(19) United States
(12) Patent Application Publication
(10) Pub. No.: US 2016/0196617 A1
(43) Pub. Date: Jul. 7, 2016

(54) SYSTEM AND METHOD FOR INDUCING USERS TO CLAIM REFUNDS

(71) Applicant: Vatbox, Ltd., Herzliya (IL)

(72) Inventors: Isaac SAFT, Kfar Neter (IL); Noam GUZMAN, Ramat Hasharon (IL)

(73) Assignee: Vatbox, Ltd., Herzliya (IL)

(21) Appl. No.: 14/989,522

(22) Filed: Jan. 6, 2016

Related U.S. Application Data
(60) Provisional application No. 62/100,577, filed on Jan. 7, 2015.

(51) Int. Cl. G06Q 40/00; G06Q 20/10

(52) U.S. Cl. CPC G06Q 40/123; G06Q 20/102

(57) ABSTRACT

A system and method for inducing users to claim refunds are provided. The method includes receiving a location of a user device; determining, based in part on the received location, whether a reclaim for a purchase made at the location is allowable; determining a type of electronic inducement for the reclaim, when the reclaim is allowable; and sending an electronic inducement of the determined type to the user device.

### CROSS-REFERENCE TO RELATED APPLICATIONS

This application claims the benefit of U.S. Provisional Application No. 62/100,577 filed on Jan. 7, 2015, the contents of which are hereby incorporated by reference.

### TECHNICAL FIELD

The present disclosure relates generally to computerized refund platforms, and more specifically to systems and methods for incenting users to reclaim VATs.

### BACKGROUND

The Value-Added Tax (VAT) is a broadly based consumption tax assessed on the value added to goods and services. A particular VAT applies to most goods and services that are bought or sold within a given country. When a person travels abroad and makes a purchase that requires paying a VAT, that person may be entitled to a subsequent refund of the VAT for the purchase. Other taxes applied to purchases may similarly be refunded under particular circumstances. Further, sellers may offer rebates for purchases of products sold in certain locations and under particular circumstances. Such refunds of the purchase price may be reclaimed by following procedures established by the refunding entity.

The laws and regulations of many countries allow foreign travelers the right for reimbursement or a refund of certain taxes such as, e.g., VATs paid for goods and/or services abroad. As such laws and regulations are different from one country to another, determination of the actual VAT refunds that one is entitled to receive often requires that the seeker of the refund possess a vast amount of knowledge in the area of tax laws abroad. Moreover, travelers may seek refunds for VATs when they are not entitled to such refunds, thereby spending time and effort on a fruitless endeavor. Further, availability of the VAT refund may vary based on the type of purchase made and the presence of a qualified VAT receipt.

One procedure to request a refund is to physically approach a customs official at, for example, an airport, fill out a form, and file the original receipts respective of the expenses incurred during the visit. This procedure should be performed prior to checking in or boarding to the next destination. Additionally, particularly with respect to goods purchased abroad, the procedure to request a refund may require that the payer show the unused goods to a custom official to verify that the goods being exported match the goods that the payer paid VATs on.

As travelers are not familiar with specific laws and regulations for claiming a refund, the travelers may submit a claim for a refund even though they are not eligible. This procedure further unnecessarily wastes time if the traveler ultimately learns that he or she is not entitled to any refund.

Furthermore, due to the hassles associated with claiming refunds and, in particular, VAT refunds, customers may not be motivated to seek such refunds. Particularly with respect to potentially large refunds, properly managed refunding platforms may be crucial for saving money. As an example, a VAT refunding platform may be important to large enterprises requiring their employees to travel for business purposes. When employees are not given incentives for obtaining the proper refunds, they are much less likely to successfully complete the refund process.

It would therefore be advantageous to provide a solution that would overcome the deficiencies noted above with respect to issuing VAT refunds.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” may be used herein to refer to a single embodiment or multiple embodiments of the disclosure.

Some of the disclosed embodiments include a method for inducing users to claim refunds. The method comprises receiving a location of a user device; determining, based in part on the received location, whether a reclaim for a purchase made at the location is allowable; determining a type of electronic inducement for the reclaim, when the reclaim is allowable; and sending an electronic inducement of the determined type to the user device.

Some of the disclosed embodiments also include a system for inducing users to claim refunds. The system comprises: a processing unit; and a memory, the memory containing instructions that, when executed by the processing unit, configure the system to: receive a location of a user device; determine, based in part on the received location, whether a reclaim for a purchase made at the location is allowable; determine a type of electronic inducement for the reclaim, when the reclaim is allowable; and send an electronic inducement of the determined type to the user device.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe the various disclosed embodiments.

FIG. 2 is a flowchart illustrating a method for providing incentives to users for VAT reclaims according to an embodiment.

FIG. 3 is a flowchart illustrating a method for determining a type of incentive to provide to users to incent them to reclaim VATs according to an embodiment.

FIG. 4 is a flowchart illustrating a method for determining whether a captured invoice qualifies for a VAT reclaim according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

According to various exemplary embodiments, a location of a user device is received. Based on the location, it is determined whether a reclaim is possible. Upon determining that a reclaim is possible, a type of electronic incentive to be provided to the user and a time for delivering the electronic incentive are determined. The determined electronic incentive is provided to the user device at the determined time.

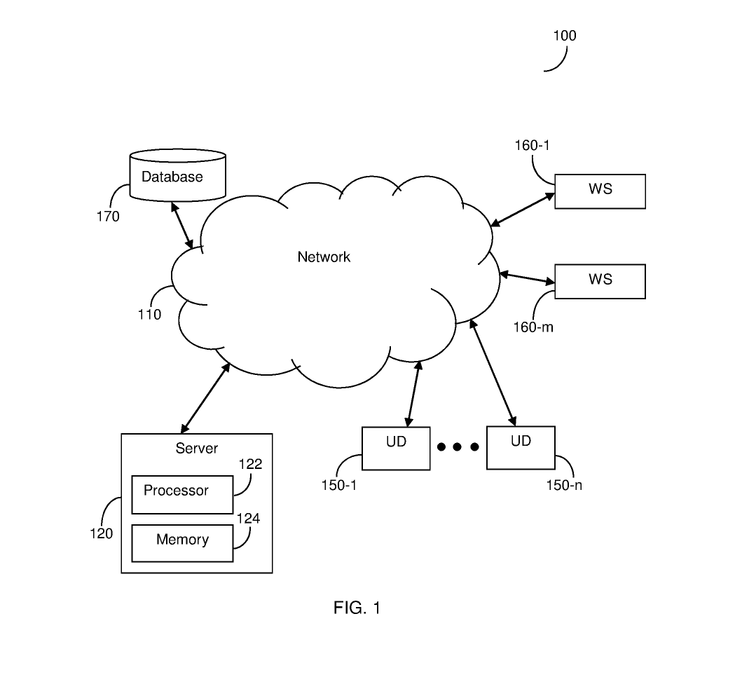

FIG. 1 shows an exemplary and non-limiting network diagram 100 utilized to describe the various disclosed embodiments. In an embodiment, the network diagram 100 includes a network 110 communicatively connected to a server 120, a plurality of user devices 150-1 through 150-n (hereinafter referred to individually as a user device 150 and collectively as user devices 150, merely for simplicity purposes), a plurality of web sources 160-1 through 160-m (hereinafter referred to individually as web sources 160 and collectively as web sources 160, merely for simplicity purposes), and a database 170. The network 110 may be, but is not limited to, a wireless, cellular or wired network, a local area network (LAN), a wide area network (WAN), a metro area network (MAN), the Internet, the worldwide web (WWW), similar networks, and any combination thereof.

Each user device 150 may be, but is not limited to, a personal computer (PC), a notebook computer, a cellular phone, a smartphone, a tablet device, a wearable computing device, and so on. Each user device 150 may include a plurality of sensors 155, such as but are not limited to, global positioning systems (GPSs), network sensors, or any other sensors that can be utilized to extract a position of the signal.

In an embodiment, the server 120 may be configured to receive a location of the user device 150. In an embodiment, the location may be based on signals generated by the sensors 155. In another embodiment, the location may be further based on metadata related to the user and/or the user device. As an example, if metadata related to the user includes a travel itinerary of the user, the location may be based on the itinerary respective of the current time.

Based on the location, the server 120 is configured to determine whether the user device 150 is at a location where a VAT reclaim may be possible. The determination may include extracting data respective of the location of the user device 150 from any of the web sources 160. The web sources 160 may be, but are not limited to, databases in which data regarding reclaim information is stored. Such databases may include, for example, VAT information exchange systems (VIESs), tax authority databases, rebate sharing systems, and so on. In another embodiment, data regarding locations at which reclaims were successfully made by the user devices 150 may be extracted from the database 170. The database 170 may store such data respective of previous reclaims by the user devices 150.

In a further embodiment, determining whether the user device 150 is at a location where a reclaim may be possible also includes identifying metadata respective of the user device 150. The metadata may include, but is not limited to, an origin of a user of the user device 150 (e.g., a home location of the user of the user device 150), past locations related to the user device 150, past actions performed by a user of the user device 150, whether the user is a tourist or on a business trip, a travel itinerary of the user of the user device, and so on. A travel itinerary may include, but is not limited to, countries or other regions which the user will be in at various times, a time of departure from a hotel or other place of lodging, intermediate locations (i.e., locations through which the user will travel to arrive at his or her destination), and so on.

In an embodiment, determining whether the user device is at a location where a reclaim may be possible may include, but is not limited to, determining whether the location includes a merchant (i.e., a seller of goods and/or services), identifying a type of the merchant (e.g., a shop, an airport, a hotel, a restaurant, and so on), and/or determining whether the identified type of merchant may be eligible for refunds. Each merchant may be categorized into more than one type respective of different goods or services sold by the merchant. As an example, if the location of the user device is determined to be at a restaurant in Italy, it may be determined that the merchant sells only food, which is not subject to VAT. Accordingly, it is determined that the user is not entitled to a VAT refund for any transactions made at that location. As another example, if the location of the user device is determined to be at a grocery store in Canada, it may be determined that the merchant sells groceries as well as other goods, some of which may be subject to VAT. Accordingly, it is determined that the user may be entitled to a VAT refund for transactions made at that location.

Upon determination that a user at the location of the user device 150 may be entitled to a refund, the server 120 is configured to determine a type of electronic inducement to provide to the user device 150 to increase the probability that the user will seek the reclaim. The electronic inducements may include, but are not limited to, a notification reminding the user to perform the steps needed to complete the reclaim. Such steps may include, for example, capturing an image of an invoice, sending the image of the invoice, requesting certain forms, filling out the forms, sending the forms, and so on.

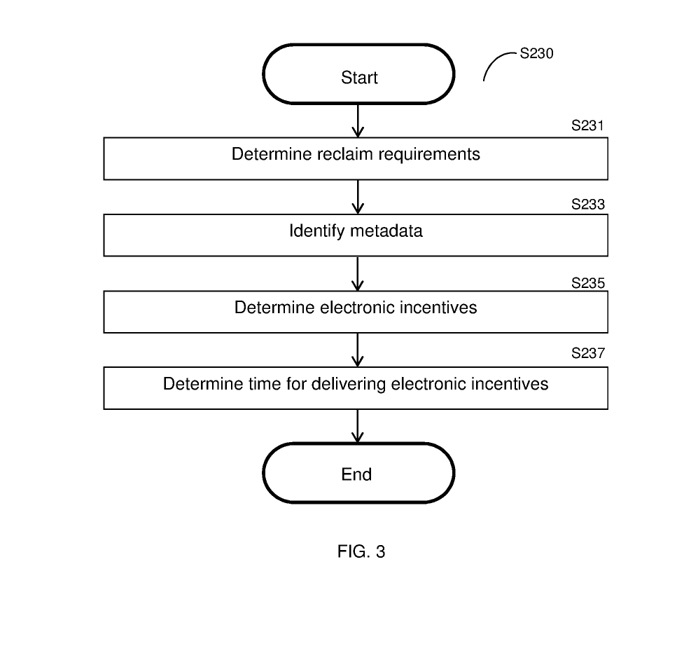

In another embodiment, the electronic inducement may be used as an advertising platform, thereby enabling provision of financial incentives via the user device 150. Providing financial incentives may include, but is not limited to, sending a coupon for display on the user device, sending a notification of a financial incentive to the user device, crediting an account of a user of the user device, and so on. Determining electronic inducements to be provided to users is described further herein below with respect to FIG. 3.

The server 120 is further configured to determine a time for delivering the electronic inducement to the user device 150 upon determination that a user at the location of the user device 150 may be eligible for a VAT reclaim. The time determination may be based on the location of the user device and/or based on the steps required to complete the VAT reclaim. As a non-limiting example, if the location of the user is determined to be at a hotel, the time for delivering the electronic inducement to the user device may be determined to be 30 minutes before checkout from the hotel. The server 120 may be configured to provide an electronic incentive of the determined type at the determined time.

In a further embodiment, the server 120 may be configured to receive a request for a VAT reclaim and at least one image of an invoice respective of the provided electronic incentives. The server 120 is configured to analyze the received image to determine whether the transaction represented in the image qualifies for a VAT reclaim. The analysis may include utilizing image and/or character recognition. Elements within the image may be identified respective of the image and/or character recognition. The server 120 is configured to check the eligibility of the VAT reclaim based on the identified elements. The check may include matching the identified elements to the required elements for VAT reclaims stored in the database 170 respective of the location and/or the metadata. It should be noted that different countries, regions, communities, and so on may have different requirements for VAT reclaim eligibility. Upon determination that the transaction may be eligible for a VAT reclaim, the server 120 is configured to send the image for further processing (e.g., for analysis by a VAT refund entity). Upon determining that the transaction is not eligible for a VAT reclaim, incentives for providing an image showing a qualifying transaction may be provided to the user device 150.

The server 120 typically includes a processing unit 122 coupled to a memory 124. The processing unit 122 may comprise or be a component of a processor (not shown) or an array of processors coupled to the memory 124. The memory 124 contains instructions that can be executed by the processing unit 130. The instructions, when executed by the processing unit 122, cause the processing unit 122 to perform the various functions described herein. The one or more processors may be implemented with any combination of general-purpose microprocessors, multi-core processors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

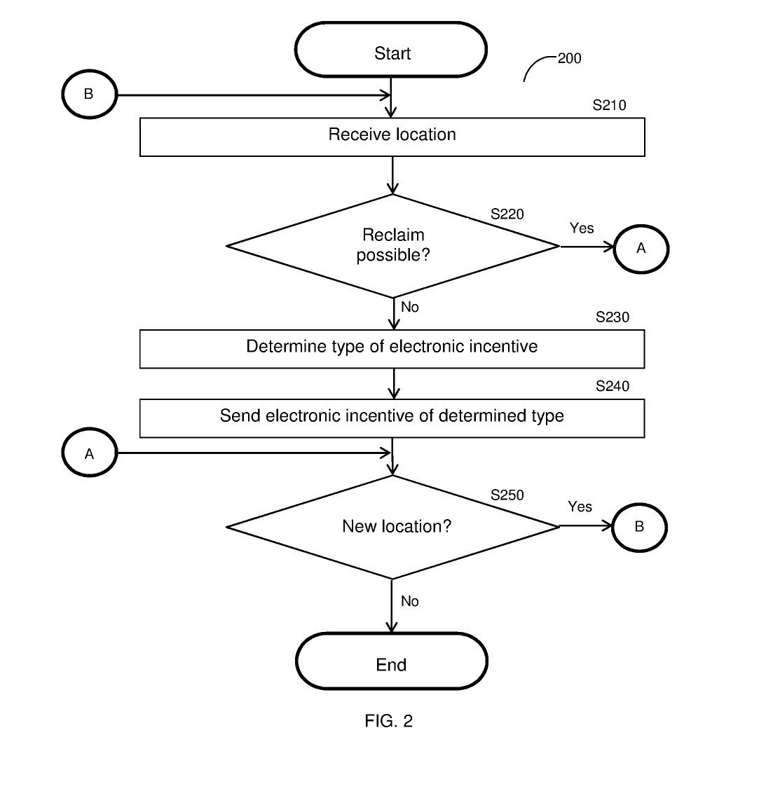

FIG. 2 is an exemplary and non-limiting flowchart 200 illustrating a method for providing electronic inducements to users for encouraging reclaims according to an embodiment. In an embodiment, the method may be performed by a server (e.g., the server 120).

In S210, a location of a user device is received. The location may be based on, e.g., a position signal indicating a position of the user device (e.g., a GPS signal), a location of a source of a network connection (e.g., a location of a router to which the user device is connected), a travel itinerary of the user and a current time, and so on. In an embodiment, S210 may further include identifying metadata respective of the user device. As noted above, metadata may include, for example, a home location, past locations, past actions performed by a user of the user device, whether the user is a tourist or on a business trip, travel itineraries, and so on.

In S220, it is checked whether a reclaim is allowable for the received location and, if so, execution continues with S230; otherwise, execution continues with S250. The check may include, but is not limited to, determining whether the location includes a merchant (i.e., a seller of goods and/or services), identifying a type of the merchant, and determining whether purchases made from the identified type of merchant at the location may entitle the user to a reclaim.

For a VAT reclaim, determining whether purchases made from the identified type of merchant at the location may entitle the user to a VAT reclaim may further include determining whether the location is in a foreign country respective of the origin of the user device. The determination of whether the location is in a foreign country may be based on, e.g., the metadata. Additionally, for a VAT reclaim, S220 may further include determining whether the refund is in a territory that allows VAT reclaims. As an example, England allows VAT reclaims for purchases made in the country, but the United States of America does not allow VAT reclaims. If the refund is not in a territory that allows VAT reclaims, a reclaim will not be allowable regardless of any merchants at the location.

In S230, a type of electronic inducement to be provided to the user device to encourage VAT reclaims is determined. Determining electronic inducements is described further herein below with respect to FIG. 3. In an embodiment, S230 may further include determining a time for delivering the electronic inducement. The determination of time for delivering the electronic inducement may be based on, but not limited to, the metadata, the location, and a combination thereof.

In S240, the determined type of electronic inducement and/or the determined time are sent to the user device. In S250, it is checked whether the location of the user device has changed and, if so, execution continues with S210; otherwise, execution terminates. The location may have changed if, e.g., a difference in the position of the user between two points in time is above a predetermined threshold (e.g., 50 feet, 100 feet, and so on).

As a non-limiting example, GPS coordinates of a location in France are received. Based on the received coordinates, it is determined that the location includes a merchant who sells jewelry with VAT and that the location is foreign relative to the origin of the user device. Accordingly, it is determined that purchases from this merchant may be eligible for VAT reclaims. An electronic incentive including a notification asking the user of the user device to obtain an invoice and to request supporting documentation from the merchant is determined. A time for delivering the electronic incentive within 15 minutes of arrival at the location is determined. The determined electronic incentive and time are sent to the user device.

FIG. 3 is an exemplary and non-limiting flowchart S230 illustrating a method for determining a type of electronic inducement to provide to a user to encourage reclaims respective of a location of a user device according to an embodiment.

In S231, requirements for successfully obtaining a reclaim in the location are determined. The determination may be based on data extracted from one or more web sources (e.g., the web sources 160) respective of the location. Different locations may have different reclaim requirements or availability. For example, a VAT reclaim in Turkey may require providing an invoice showing at least 100 lire worth of purchases, while a VAT reclaim in Ireland may not have any minimum purchase requirement.

In S233, metadata respective of the user device and/or a user of the user device is identified. The metadata may include, but is not limited to, an origin (e.g., a country, a community, a region, and so on) of the user and/or the user device past locations related to the user device 150, past actions performed by the user device 150, whether the user is a tourist or on a business trip, travel itineraries of the user of the user device, and so on. Reclaim requirements may differ respective of place of origin. As an example, a VAT reclaim in Estonia may require demonstration that the user is a VAT taxpayer in his or her home country (i.e., that the origin of the user is a country having a VAT). VAT requirements may further differ based on the status of the user (i.e., whether the user is travelling as a tourist or as a business person). Typically, some products are eligible for VAT refunds for business persons but not for tourists.

In S235, electronic inducements for encouraging the user to complete a reclaim are determined. The inducements may include, but are not limited to, notifications regarding required items, notifications reminding the user to show his or her passport when making a purchase, financial incentives, and so on.

In optional S237, a time for delivering each electronic inducement may be determined. The determined time may be immediate or may be delayed. In an embodiment, the times may be determined respective of the required items. As an example, the time for providing an electronic inducement reminding the user to obtain a valid invoice including rebate information may be 10 minutes after a new location is received. In a further embodiment, the times may be further determined based on the location of the user device. As another example, a time for delivering an electronic inducement reminding the user to seek out a VAT refund agent may be determined to be when the user arrives at an airport.

As a non-limiting example, respective of a location indicating that the user is in a furniture store in Turkey, VAT reclaim requirements are determined. The VAT reclaim requirements include a minimum total price of CAT eligible goods of 100 lira as well as an invoice showing elements such as serial number, date of purchase, identifying information of the seller, description of the goods or services, quantity of each product, and price of each product. Metadata indicating that the origin of a user claiming the VAT through the user device is the United States of America is identified. A notification reminding the user to obtain an invoice showing the required reclaim elements as well as a tax-free form is determined as an electronic incentive. A time for delivering the notification is determined to be immediately (i.e., before the user can complete a purchase).

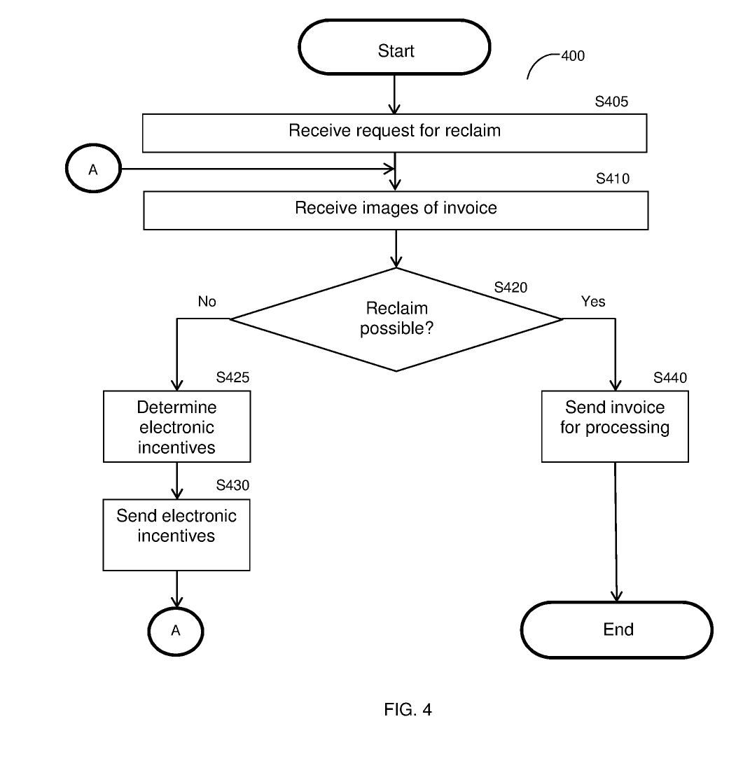

FIG. 4 is an exemplary and non-limiting flowchart 400 illustrating a method for determining whether a captured invoice is eligible for a reclaim according to an embodiment. As described further herein above, different locations may have different regulations regarding the procedure of obtaining a reclaim. The method of FIG. 4 allows for determination of whether a particular invoice is suitable according to such regulations.

In S405, a request for a reclaim at a location is received. The location may be determined by, e.g., a GPS signal of a user device. The request may be received in response to, for example, a capture of an invoice for a purchase made at the location.

In S410, an image of an invoice is received. The image may be captured via a sensor of the user device such as, but not limited to, a still image camera, a video camera, a scanner, and so on. In S415, the image is analyzed. The analysis may include image and/or character recognition as described further herein above. The image and/or character recognition may result in identification of elements in the invoice related to a potential reclaim respective of the received location. Elements that may be identified include, but are not limited to, a name of a product (i.e., name of a good or service), a price per product, a total price, a date of purchase,

In S420, it is checked whether the invoice indicates a purchase that may be eligible for a reclaim and, if so, execution continues with S440; otherwise, execution continues with S425. The check may include analyzing the identified elements in the captured image respective of the location of the user device. The analysis may result in a determination of whether the identified elements satisfy the reclaim requirements respective of the received location and/or the origin.

In S425, upon determining that the invoice is not eligible for a reclaim, electronic incentives for encouraging the user to provide a qualifying invoice may be determined. The electronic incentives may include, but are not limited to, a notification that the captured invoice does not qualify for a reclaim, a notification identifying which invoice elements are missing or otherwise ineligible (e.g., which elements make the purchase unsuitable for a reclaim at the location), and so on. In an embodiment, S425 may further include determining a time for providing the electronic incentives.

In S430, the determined electronic incentives are sent to the user device and execution continues with S410. The determined electronic incentives may be sent to the user device at the determined time. Sending the electronic incentives at the determined time may include receiving additional locations of the user device and sending the electronic incentives respective of the additional locations. As an example, an electronic incentive may be sent when a user arrives at an airport.

In S440, upon determining that the purchase illustrated in the invoice is eligible for a reclaim, the qualified invoice is sent for processing. The qualified invoice may be sent to an appropriate refunding agency such as, but not limited to, a tax authority, an accountant, and so on. S440 may further include generating a reclaim request including the qualified invoice. In an embodiment, the reclaim request may be generated as described further in co-pending U.S. patent application Ser. No. 14/575,115 filed on Dec. 18, 2014, assigned to the common assignee, which is hereby incorporated by reference for all that it contains.

In S445, it is checked whether execution should continue and, if so, execution continues with S405; otherwise, execution terminates.

It should be noted that the method for providing electronic incentives to users as described in FIG. 2 may be integrated with the method for determining whether a captured invoice is eligible for a reclaim as described in FIG. 4 without departing from the scope of the disclosure.

It should be noted that, although the embodiments described herein are discussed with respect to VATs, the various disclosed embodiments may be applicable to other refunds such as, e.g., refundable sales taxes, rebates, and so on.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for inducing users to claim refunds, comprising:
receiving a location of a user device;
determining, based in part on the received location, whether a reclaim for a purchase made at the location is allowable;
determining a type of electronic inducement for the reclaim, when the reclaim is allowable; and
sending an electronic inducement of the determined type to the user device.

2. The method of claim 1, wherein determining the type of electronic incentive further comprises:
determining a time for sending the electronic inducement; and
sending the electronic inducement to the user device at the determined time.

3. The method of claim 1, further comprising:
receiving a request for a reclaim in response to the electronic incentive, wherein the request for the reclaim includes at least an image of at least one invoice;
analyzing the received image; and
determining, based on the analysis, whether each of the at least one invoice illustrated in the received image is eligible for a reclaim.

4. The method of claim 3, further comprising:
sending each image featuring an eligible invoice for reclaim processing.

5. The method of claim 1, wherein determining whether the reclaim for the purchase made at the location is allowable further comprises:
determining whether purchases made at the location can be refunded.

6. The method of claim 5, wherein determining, based in part on the received location, whether the reclaim for the purchase made at the location is allowable further comprises:
determining whether the received location includes a merchant location;
identifying at least one type of merchant at the location; and
determining whether purchases made from the identified at least one type of merchant may be eligible for reclaims.

7. The method of claim 1, wherein determining the type of the electronic inducement further comprises:
determining at least one reclaim requirement respective of the location.

8. The method of claim 7, further comprising:
determining a time for delivering the electronic inducement based on the determined at least one reclaim requirement.

9. The method of claim 7, wherein determining the at least one reclaim requirement is further based on an origin of a user the user device.

10. A non-transitory computer readable medium having stored thereon instructions for causing one or more processing units to execute the method according to claim 1.

11. A system for inducing users to claim refunds, comprising:
a processing unit; and
a memory, the memory containing instructions that, when executed by the processing unit, configure the system to:
receive a location of a user device;
determine, based in part on the received location, whether a reclaim for a purchase made at the location is allowable;
determine a type of electronic inducement for the reclaim, when the reclaim is allowable; and
send an electronic inducement of the determined type to the user device.

12. The system of claim 11, wherein the system is further configured to:
determine a time for sending the electronic inducement; and
send the electronic inducement to the user device at the determined time.

13. The system of claim 11, wherein the system is further configured to:
receive a request for a reclaim in response to the electronic incentive, wherein the request for the reclaim includes at least an image of at least one invoice;
analyze the received image; and
determine, based on the analysis, whether each of the at least one invoice illustrated in the received image is eligible for a reclaim.

14. The system of claim 13, wherein the system is further configured to:
send each image featuring an eligible invoice for reclaim processing.

15. The system of claim 11, wherein the system is further configured to:
determine whether purchases made at the location can be refunded.

16. The system of claim 15, wherein the system is further configured to:
determine whether the received location includes a merchant location;
identify at least one type of merchant at the location; and
determine whether purchases made from the identified at least one type of merchant may be eligible for reclaims.

17. The system of claim 11, wherein the system is further configured to:
determine at least one reclaim requirement respective of the location.

18. The system of claim 17, wherein the system is further configured to:
determine a time for delivering the electronic inducement based on the determined at least one reclaim requirement.

19. The system of claim 17, wherein determining the at least one reclaim requirement is further based on an origin of a user of the user device.
